(19) United States
(12) Patent Application Publication
(10) Pub. No.: US 2012/0247304 A1
(43) Pub. Date: Oct. 4, 2012

(54) LEATHER PLECTRUM

(75) Inventor: Stuart Adam Jay, Sheridan, CO (US)

(73) Assignee: Stuart Adam Jay, Sheridan, CO (US)

(21) Appl. No.: 13/436,415

(22) Filed: Mar. 30, 2012

Related U.S. Application Data
(60) Provisional application No. 61/470,012, filed on Mar. 31, 2011.

(51) Int. Cl. G10D 3/16

(52) U.S. Cl. 84/322

(57) ABSTRACT

The foregoing describes a plectrum. In embodiments, the plectrum is comprised of hardened leather. The hardened leather may be beveled and/or sharpened. In other embodiments, the construction of the hardened leather plectrum may include a hole, or eyelet, for incorporating a lanyard. In other embodiments, a method of making a leather plectrum is disclosed.

The present application is in the technical field of music. More particularly, the present application is in the technical field of plectrums typically designed to be used with for striking the strings of guitars, basses, and other stringed instruments to produce sound from those instruments. In one embodiment, the present disclosure describes a leather plectrum with a hardened beveled or hardened sharpened end or edges used for striking the strings of guitars, basses, and other stringed instruments to produce sound from those instruments with optional lanyard. In another embodiment, the present disclosure describes a process for making a leather plectrum.

### SUMMARY

The foregoing describes a plectrum. In embodiments, the plectrum is comprised of hardened leather. The hardened leather may be beveled and/or sharpened. In other embodiments, the construction of the hardened leather plectrum may include a hole, or eyelet, for incorporating a lanyard.

### BRIEF DESCRIPTION OF DRAWINGS

FIG. 1 is a front/rear perspective view of a leather plectrum.

FIG. 2 is a left/right side view of a leather plectrum.

FIG. 3 is a near front/near rear perspective view of a leather plectrum.

FIG. 4 is a near front/near rear perspective view of a leather plectrum showing optional lanyard.

### DETAILED DESCRIPTION

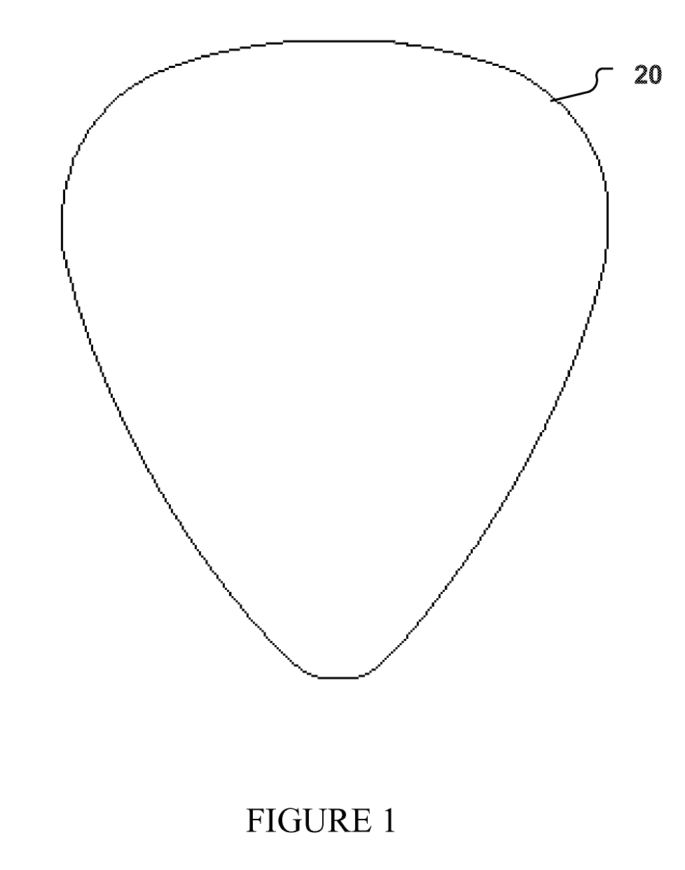

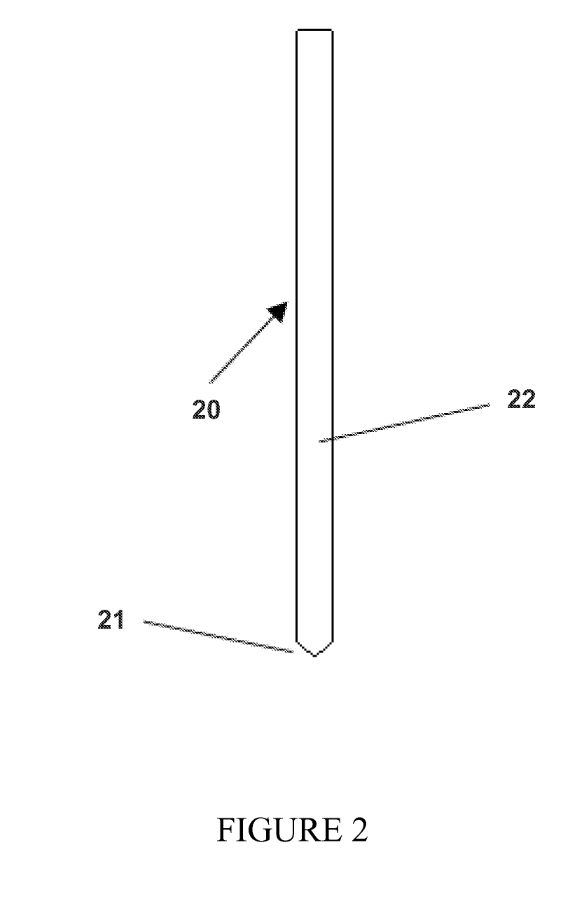

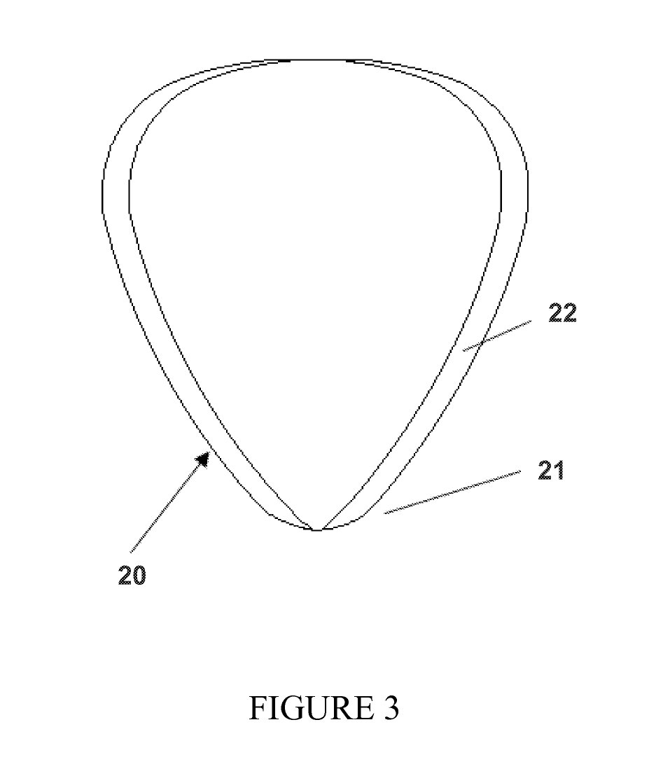

The present disclosure provides for a leather plectrum. Referring now in more detail to FIG. 1, FIG. 2, and FIG. 3 there is shown a plectrum 20 made of leather. In further detail, there is shown in FIG. 2 and FIG. 3 the end of the leather plectrum having a hardened beveled or hardened sharpened end 21 that is sufficiently stiff and responsive enough to strike a stringed instrument. Alternatively, and/or in addition to having a hardened beveled or hardened sharpened end 21 that is sufficiently stiff and responsive enough to strike a stringed instrument, the hardened beveled or hardened sharpened end that is sufficiently stiff and responsive enough to strike a stringed instrument can be extended the entirety of all of the edges of the plectrum 22.

In further detail, there is shown in FIG. 2 and FIG. 3 an increased thickness 22 of the leather plectrum. The increased thickness is advantageous over the thickness of plectrums found on the market today. The thickness may be anywhere between 1-10 mm, with a desired thickness between 2-7 mm.

The construction details of the disclosure as shown in FIG. 1, FIG. 2, and FIG. 3 are that the leather plectrum 20 may be made of leather or of any other material such as composite leather, or artificial leather. Further, the various components of the leather plectrum 20 can be made of different materials.

The leather plectrum 20 may be hardened by any method of leather hardening known in the art. Hardening leather may include any hardening method that makes the leather stiffer. These hardening methods may include, but are not limited to, hardening by use of liquid and/or chemical process. In addition heat may be applied as necessary to achieve the desired level of plectrum hardness. The use of liquid, chemical, and/or heat may be combined to create the hardened leather. Moreover, the liquid may be heated or boiled. In yet another embodiment, the exterior surface to be hardened may be exposed directly to flame to create a hardened leather portion.

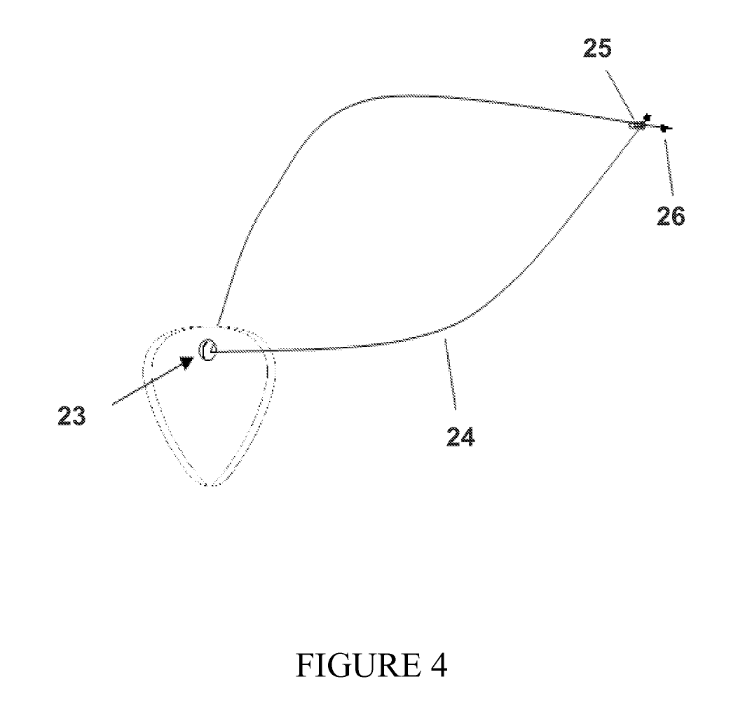

The construction details of the disclosure as shown in FIG. 1, FIG. 2, and FIG. 3 and as described above may, alternatively, and as shown in FIG. 4, incorporate via an eyelet 23, grommet, hole or the like in the plectrum a lanyard 24 tied together by common slipknot 25 or similar method and tied off at each end 26 to permit the lanyard to be secured around the wrist to enable the holder of the plectrum to use the plectrum to strike the stringed instrument. Moreover, the lanyard secured around the wrist enables the holder to let the plectrum drop from the holder's fingers while keeping the plectrum secured to the wrist for easy retrieval. The length of the lanyard 24 may be made long enough to permit the lanyard and plectrum to be placed around the neck of the holder in a necklace-like fashion.

The present disclosure offers numerous advantages over previous plectrum designs. The hardened beveled or hardened sharpened end 21 of the plectrum offers a different sonic response depending on the level of hardness incorporated. For example, an increased level of hardness, i.e. a harder, end of the plectrum may offer improved high frequency sonic response and clarity. Alternatively, a decreased level of hardness, i.e. softer, end of the plectrum may offer a muted response. Depending on the intended sonic effect, different levels of hardness on the hardened beveled or hardened sharpened end 21 of the plectrum may be desired. Moreover, the plectrum may be constructed such that different levels of hardness are incorporated at different areas of the edge, creating unique sonic responses depending where on the plectrum a string is struck.

Additionally, the non-hardened portion of the plectrum is as tactile, as grip-able, and as malleable as plectrums on the market today. The increased hardness may enable the user to more easily grip and pick up the plectrum when it is placed on a flat surface.

Embodiments of the plectrum may be considered to be substantially all leather. That is, the main functional element of the plectrum is entirely of leather notwithstanding other ornamental elements, such as ink, plastic or embossed metal that may be provided for aesthetic or identification purposes. For example, in an embodiment, a leather plectrum is provided that includes a minor amount of rubber on the surface of the plectrum. The rubber may be provided as a trademark identifier but could also be said to improve the user's grip. However, such a plectrum would be considered to be a leather plectrum within the scope of this disclosure as the rubber is a minor element and superfluous to the plectrum's function of plucking the strings of an instrument.

In one embodiment, the plectrum may be attached to a lanyard 24. The lanyard 24 enables the holder of the plectrum to use the plectrum to strike the stringed instrument, but also enables the user to let the plectrum drop from the fingers while keeping the plectrum secured to the wrist for easy retrieval. Additionally, the length of the lanyard 24 may be made long enough to permit the lanyard and plectrum to be placed around the neck of the holder in a necklace-like fashion.

It will be clear that the apparatus described herein is well adapted to attain the ends and advantages mentioned as well as those inherent therein. Those skilled in the art will recognize that the methods and systems within this specification may be implemented in many manners and as such is not to be limited by the foregoing exemplified embodiments and examples.

While various embodiments have been described for purposes of this disclosure, various changes and modifications may be made which are well within the scope of the present invention. Numerous other changes may be made which will readily suggest themselves to those skilled in the art and which are encompassed in the spirit of the disclosure.

I claim:

1. A plectrum consisting substantially of leather.

2. The plectrum of claim 1, wherein at least a portion of the plectrum is hardened leather.

3. The plectrum of claim 2, wherein the hardened leather portion is beveled.

4. The plectrum of claim 2, wherein the hardened leather portion is sharpened.

5. The plectrum of claim 2, wherein the plectrum further comprises a hole for incorporating a lanyard.

6. The plectrum of claim 2, wherein the hardened leather is at an edge of the plectrum.

7. The plectrum of claim 2, wherein different levels of hardness are incorporated at different areas of the plectrum.

8. The plectrum of claim 1, wherein the leather is hardened using any of liquid, chemical, and/or thermal processes.

9. The plectrum of claim 1, wherein the plectrum is between 1 mm and 10 mm in thickness where the plectrum is gripped by a user.

10. A method of creating a leather plectrum comprising:
cutting a sheet of leather into a desired plectrum shape; and
selectively hardening a portion of the leather.

11. The method of claim 10 further comprising:
exposing the portion of the leather to heat.

12. The method of claim 11 further comprising:
exposing the portion of the leather to flame.

13. The method of claim 12 further comprising:
igniting the portion of the leather.

14. The method of claim 9 further comprising:
forming a hole in the leather.

15. The method of claim 9 further comprising:
exposing the portion of the leather to a liquid.

16. The method of claim 9, wherein the liquid is heated before the portion of the leather is exposed to the liquid.

17. The method of claim 15 further comprising:
exposing the portion of the leather to a chemical.

18. The method of claim 15 further comprising:
after exposing the portion of the leather to the liquid, exposing the portion of the leather to heat.

19. The method of claim 15 further comprising:
after exposing the portion of the leather to the liquid, exposing the portion of the leather to a flame.

20. The method of claim 14 further comprising:
securing a lanyard through the hole.
